(19) United States
(12) Patent Application Publication
(10) Pub. No.: US 2001/0034978 A1
(43) Pub. Date: Nov. 1, 2001

(54) Automotive light transmitting panel mounting structure

(76) Inventors: Yasushi Iimori, Aichi-ken (JP); Hajime Hasegawa, Aichi-ken (JP); Hiroshi Kuno, Aichi-ken (JP)

Correspondence Address: Steven J. Rocci, Esq., WOODCOCK WASHBURN KURTZ, MACKIEWICZ & NORRIS LLP, One Liberty Place - 46th Floor, Philadelphia, PA, 19103, US

(21) Appl. No.: 09/843,369

(22) Filed: Apr. 26, 2001

(30) Foreign Application Priority Data
Apr. 28, 2000 (JP) 2000-131106

(51) Int. Cl. E06B 3/00; E05D 15/06

(52) U.S. Cl. 49/490.1; 49/498.1; 49/413

(57) ABSTRACT

An automotive light transmitting panel mounting structure for mounting a light transmitting panel to a frame, includes: a frame having a mounting flange; a light transmitting panel bonded relatively movably to the frame; a weather strip held by the mounting flange of the frame for sealing a space between the frame and the light transmitting panel; and elastic sealing material filled in a space surrounded by the frame, the light transmitting panel and the weather strip. The weather strip includes: a body portion; a leg portion extending from the body portion to face the body portion for clamping the mounting flange of the frame in cooperation with the body portion; and a contact lip projecting from the leg portion in elastic contact with an end face of the light transmitting panel so that the elastic sealing material is prevented from entering between the leg portion and the contact lip.

### BACKGROUND OF THE INVENTION

1. Field of the Invention

The present invention relates to an automotive light transmitting panel mounting structure that is used when, for example, a sunroof panel of an automotive sunroof or other similar automotive light transmitting panels are to be mounted on a frame.

2. Description of the Related Art

Conventionally, in, for example, an automotive body, a sunroof is provided in a roof panel of the body in order to brighten an automotive interior or to enhance opening feel of the automotive interior. A sunroof panel (light transmitting panel) as a light window portion of the sunroof is made of glass or synthetic resin. For instance, the sunroof panel is fixed to a metal frame by adhesives. A weather strip is arranged along an edge portion between the sunroof panel and the frame to thereby form a mounting structure for sealing the sunroof panel. Then, in the above-described sunroof using the frame, the frame formed integrally with the sunroof panel is mounted on the automotive roof panel through a slide rail structure for horizontal movement and link structure for swing motion. In some of the above-described sunroof panel mounting structures, a relative movement due to difference in linear expansion coefficient between the metal made frame and the glass or synthetic resin made sunroof panel is considered in sealing the frame and the sunroof panel. In particular, in the case where the synthetic resin made sunroof panel is used, an amount of change of the sunroof panel due to thermal expansion or thermal shrinkage is remarkable in comparison with the glass or metal. Therefore, the above-described countermeasure is needed. As to the mounting structure for coping with the above-described problem, the conventional sunroof mounting structure will now be described with reference to FIGS. 8 and 9.

As shown in a partial cross-sectional view of FIG. 8, a sunroof panel 120 is bonded relatively movably to a frame 110 by adhesives 140. A weather strip 130 is mounted on the frame 110. The weather strip 130 has a body portion 131 and a leg portion 132. A slit-like groove portion 133 is formed between these portions. Amounting flange 112 of the frame 110 is press-fitted into this groove portion 133 whereby the frame 110 is mounted on a rear surface 120b side of the sunroof panel 120. Further, for example, a V-shaped contact lip 134 projecting in a direction toward an end face 120c of the sunroof panel 120 from the leg portion 132 is formed in the weather strip 130.

This contact lip 134 having elasticity is adapted to keep the contact condition with the end face 120c of the sunroof panel 120 when the sunroof panel 120 is expanded or shrunken by temperature change in a direction indicated by an arrow 160 or 162 in FIG. 8. Namely, as shown by tow-dot-and-dash lines in FIG. 9, the contact lip 134 is adapted to move following the movement of the end face 120c of the sunroof panel 120. Also, elastic sealing material 150 having elasticity and viscosity is filled in a space surrounded by the sunroof panel 120, the frame 110 and the weather strip 130 and pressingly bonded to the back surface 120b of the sunroof panel 120, the frame 110 and the contact lip 134, respectively. Also, a slant surface 120d for preventing a shearing force or the like from being generated in the elastic sealing material 150 due to the depression from the end face 120c is formed in the end face 120c of the sunroof panel 120.

Accordingly, with the above sunroof panel mounting structure, even if the sunroof panel 120 is thermally shrunken or thermally expanded, for example, water is prevented from entering from the outside by the contact lip 134 of the weather strip 130 and the elastic sealing material 150.

However, in the above structure, in the case where there is non-uniformity in coating of the elastic sealing material 150 and the elastic sealing material 150 is introduced around and into a region 135 formed between the contact lip 134 and the leg portion 132 when the sunroof panel 120 is to be mounted on the frame 110, the movement in a direction indicated by the arrow 162 in FIG. 8, in particular, may be limited. Then, if the movement of the contact lip 134 is limited, when the sunroof panel 120 is thermally expanded or thermally shrunken, the contact lip 134 can not follow the movement of the end face 120c of the sunroof panel 120 in the direction indicated by the arrow 160 or 162 in FIG. 8. Thus, there arises a problem in that it is difficult to seal the sunroof panel 120.

Also, as shown in FIG. 9, when the sunroof panel 120 is thermally expanded or thermally shrunken, an angle defined by the slant surface 120d formed on the end surface 120 side of the sunroof panel 120 and the contact lip 134 is changed from a reference angle B1 shown in FIG. 8 to an angle B2 or B3. In the case where this angle change is remarkable, there is a problem in that the elastic sealing material 150 peels off the contact lip 134.

### SUMMARY OF THE INVENTION

Accordingly, the present invention has been made in view of the above, and an object of the present invention is to provide a light transmitting mounting technology that may seal an automotive light transmitting panel without fail when the automotive light transmitting panel is to be mounted on a frame.

In order to attain this and other objects, there is provided an automotive light transmitting panel mounting structure for mounting a light transmitting panel to a frame, comprising: a frame having a mounting flange; a light transmitting panel bonded relatively movably to the frame; a weather strip held by the mounting flange of the frame for sealing a space between the frame and the light transmitting panel; and elastic sealing material filled in a space surrounded by the frame, the light transmitting panel and the weather strip, the weather strip including: a body portion; a leg portion extending from the body portion to face the body portion for clamping the mounting flange of the frame in cooperation with the body portion; and a contact lip projecting from the leg portion in elastic contact with an end face of the light transmitting panel so that the elastic sealing material is prevented from entering between the leg portion and the contact lip.

### BRIEF DESCRIPTION OF THE DRAWINGS

FIG. 1 is a perspective view of an automotive body as viewed from the outside;

FIG. 2 is a cross-sectional view taken along the line II-II of FIG. 1 showing a light transmitting panel mounting structure in accordance with a first embodiment of the present invention;

FIGS. 3 and 4 are partially cross-sectional views showing the conditions where the light transmitting panel in the reference condition shown in FIG. 2 is thermally expanded and thermally shrunken, respectively;

FIGS. 5 to 7 are partially cross-sectional views showing light transmitting panel mounting structures in accordance with second to fourth embodiments of the present invention, respectively;

FIG. 8 is a partially cross-sectional view showing a conventional automotive light transmitting panel mounting structure; and

FIG. 9 is a view showing the movement of a contact lip shown in FIG. 8.

### DESCRIPTION OF THE PREFERRED EMBODIMENTS

An automotive light transmitting panel mounting structure in accordance with first to fourth embodiments will now be described with reference to the accompanying drawings.

Incidentally, in each of the embodiments, a sunroof panel mounting structure provided in an automotive sunroof will be described.

First Embodiment:

A light transmitting panel mounting structure in accordance with a first embodiment will now be described with reference to FIGS. 1 to 4. A sunroof 2 in which a light window portion is formed by a sunroof panel 20 is provided in a roof panel 1 of an automotive body.

Incidentally, an arrow FR in FIG. 1 indicates a front side of the vehicle and an arrow UP indicates the upper side of the vehicle.

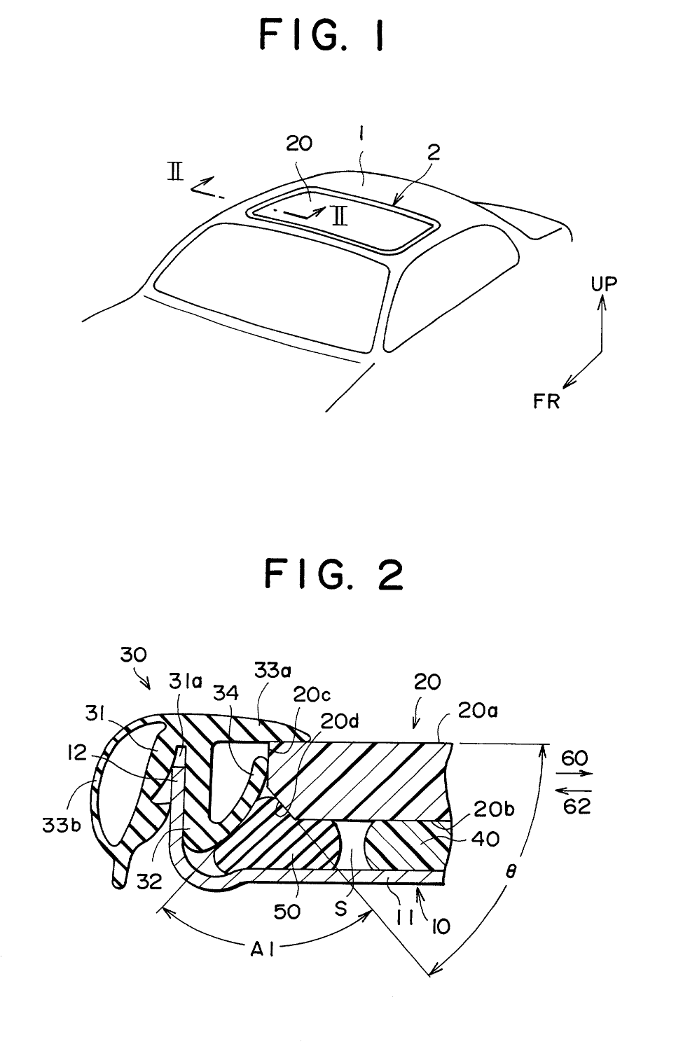

As shown in FIG. 2, in the light transmitting panel mounting structure in the first embodiment, there are provided the sunroof panel 20 as a light transmitting panel, a frame 10 on which the sunroof panel 20 is mounted, a weather strip 30 for sealing an edge portion of the sunroof panel 20, adhesives 40, elastic sealing material 50 and the like.

The frame 10 made of, for example, steel has a substantially planar main plate portion 11 and a mounting flange 12 formed by bending this main plate portion 11.

The sunroof panel 20 is in the form of a planar shape and made of, for example, polymethylmethacrylate resin, acrylic resin, or polycarbonate resin. Protective coat layers (not shown) are formed on a top surface 20a and a back surface 20b of the sunroof panel 20, respectively. The back surface 20b of the sunroof panel 20 is bonded to the main plate portion 11 of the frame 10 by the adhesives 40. Incidentally, semi-cure type adhesives such as urethane adhesives may be used as the adhesives 40. The frame 10 and the sunroof panel 20 are bonded together movably relative to each other.

The weather strip 30 has a body portion 31 and a leg portion 32 facing the body portion 31, and a slit-like groove portion 31a into which the mounting flange 12 of the frame 10 may be fitted is formed between these portions 31 and 32. The weather strip 30 is formed of, for example, rubber such as solid rubber of ethylene propylene rubber or chloroprene rubber and foamed sponge rubber or soft resin such as soft chloroethene resin. The weather strip 30 has a surface side lip 33a projecting from a top end of the body portion 31 in an inside direction (right side direction in FIG. 2) and coming into area contact with the top surface 20a of the sunroof panel 20, and an outside lip 33b projecting from the top end of the body portion 31 in an outward direction (left side direction in FIG. 2) and coming into contact with an inside surface of a window opening portion (not shown) formed in the roof panel 1.

The weather strip 30 is further provided with a piece of contact lip 34 projecting obliquely upwardly toward the end face 20c of the sunroof panel 20 from a lower end of the leg portion 32 and contacting the end face 20c of the sunroof panel 20 with elasticity. Since the contact lip 34 has elasticity, when the sunroof panel 20 is thermally shrunken or thermally expanded so that the end face 20c is moved in the direction indicated by an arrow 60 or an arrow 62 in FIG. 2, the contact lip 34 is adapted to keep the contact condition with the end face 20c of the sunroof panel 20. Since the contact lip 34 projects obliquely upwardly toward the end face 20c of the sunroof panel 20, there is no region where the elastic sealing material 50 may enter between the leg portion 32 and the contact lip 34. Thus, even if the elastic sealing material 50 is moved toward the leg portion 32 along the contact lip 34, the elastic sealing material 50 can not enter between the leg portion 32 and the contact lip 34. Accordingly, the movement of the contact lip 34 is not limited. Even in the case where the sunroof panel 20 is thermally expanded or thermally shrunken, it is possible to maintain the seal of the sunroof panel 20.

The mounting flange 12 of the frame 10 is fitted in the groove portion 31a between the body portion 31 and the leg portion 32 whereby the weather strip 30 is mounted on the frame 10. Under this condition, the surface side lip 33a of the weather strip 30 is brought into elastic area contact with the top surface 20a of the sunroof panel 20 to thereby seal the edge portion of the sunroof panel 20.

The elastic sealing material 50 having elasticity and viscosity is filled in a space S surrounded by the main plate portion 11 of the frame 10, the contact lip 34 and the back surface 20b of the sunroof panel 20. It is preferable to use as the elastic sealing material 50 material such as a rubber system hot melt elastic sealing material having performance such that even if the sunroof panel 20 is thermally expanded to be kept in the compressed condition, there is generated no high stress and in the case where the sunroof panel 20 is thermally shrunken and subjected to the tension stress, there is no fear that the end face 20c of the sunroof panel 20 is peeled off the contact lip 34 or there is no fear that the material fracture occurs.

A slant surface 20d forming a sharp angle θ relative to the surface 20a is formed in the end face 20c of the sunroof panel 20. Then, this slant surface 20d and the contact lip 34 form a predetermined angle. The slant surface 20d is provided in the end face 20c of the sunroof panel 20 so that the shearing or the like of the elastic sealing material 50 caused by the depression from the end face 20c may be prevented.

Since the contact lip 34 of the weather strip 30 projects from the lower end of the leg portion 32, the length of the contact lip 34 is elongated so that the angle defined by the contact lip 34 and the slant surface 20d of the sunroof panel 20 may be reduced as much as possible. Thus, in the case where the sunroof panel 20 is thermally expanded or thermally shrunken so that the position of the end face 20c relative to the weather strip 30 is shifted, the angular change of the angle defined by the contact lip 34 and the slant surface 20d may be reduced. Thus, it is possible to suppress the peel of the elastic sealing material 50 off the contact lip 34 as much as possible.

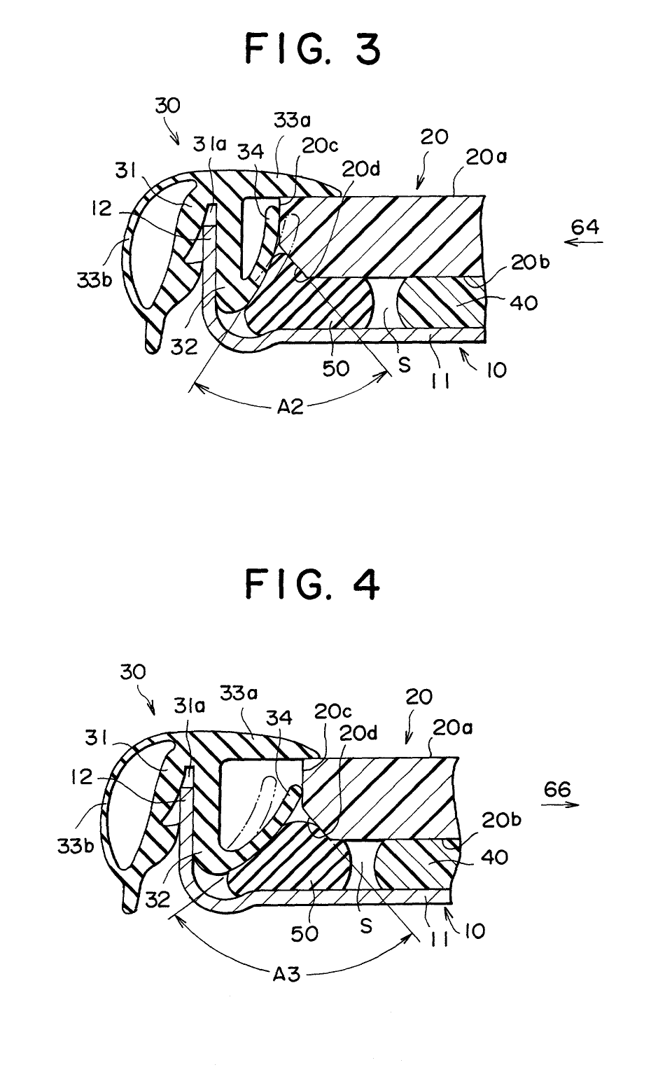

In the above-described panel mounting structure, when the sunroof panel 20 is thermally expanded from the reference condition shown in FIG. 2, as shown in FIG. 3, the contact lip 34 is depressed with stronger depression force than that of the reference condition by the end face 20c. Then, the contact lip 34 is shifted to a position indicated by the solid lines from a position indicated by tow-dot-and-dash lines, for example, under the condition that the contact lip 34 is in contact with the end face 20c of the sunroof panel 20. In this case, the angle A2 defined between the slant surface 20d of the sunroof panel 20 and the contact lip 34 of the weather strip 30 is smaller than the angle Al of the reference condition. Also, the elastic sealing material 50 that is kept in contact with the slant surface 20d of the sunroof panel 20 is compressed and deformed to thereby absorb the thermal expansion of the sunroof panel 20. Under the condition in this embodiment, it is possible to seal the sunroof panel 20 without fail with the seal structure of the contact lip 34 of the weather strip 30 and the elastic sealing material 50.

On the other hand, when the sunroof panel 20 is thermally shrunken from the reference condition shown in FIG. 2, as shown in FIG. 4, the depression force for depressing the contact lip 34 by the end face 20c is weaker than that of the reference condition in accordance with the movement of the contact face 20c of the sunroof panel 20 in the direction indicated by the arrow 66. Then, the contact lip 34 is moved from the position indicated by the two-dot-and-dash lines to the position indicated by the solid lines, for example, by its restoration force under the condition that the contact lip 34 is kept in contact with the end face 20c of the sunroof panel 20. In this case, the angle A3 defined by the slant surface 20d of the sunroof panel 20 and the contact lip 34 of the weather strip 30 is greater than the angle A1 in the reference condition.

Also, in this case, the peel of the elastic sealing material 50 that is in contact with the slant surface 20d of the sunroof panel 20 is prevented by the action of the elastic restoration force and the viscosity.

With the panel mounting structure in accordance with the first embodiment, the contact lip 34 projects substantially in the form of a flat plate obliquely upwardly toward the end face 20c of the sunroof panel 20 and there is no region that the elastic sealing material 50 enters between the leg portion 32 and the contact lip 34. Accordingly, even if the elastic sealing material 50 is moved in the direction toward the leg portion 32 along the contact lip 34, there is no region where the elastic sealing material 50 is introduced there into so that the movement of the contact lip 34 is limited. It is therefore possible to prevent the movement of the contact lip 34 being limited without fail by the elastic sealing material 50.

Also, since the contact lip 34 projects from the lower end of the leg portion 32 and the length of the contact lip 34 is elongated, even if the sunroof panel 20 is thermally expanded or thermally shrunken so that the end face 20c is moved relative to the weather strip 30, it is possible to reduce the angular change of the angle defined by the contact lip 34 and the slant surface 20d. It is possible to reduce the peel of the elastic sealing material 50 due to the increase in this angular change as much as possible.

Accordingly, with the seal structure of the contact lip 34 of the weather strip 30 and the elastic sealing material 50, it is possible to seal the sunroof panel 20 without fail.

Second Embodiment:

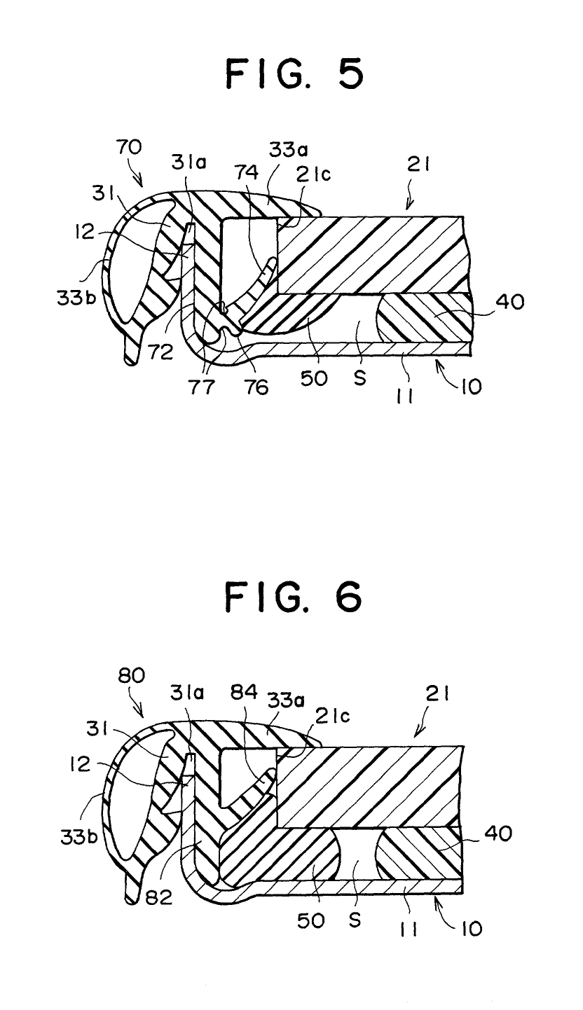

A panel mounting structure in accordance with a second embodiment will now be described with reference to FIG. 5. Incidentally, the same reference numerals are used to indicate the same or like components as shown in FIGS. 2 to 4.

As shown in FIG. 5, a contact lip 74 of a weather strip 70 in accordance with the second embodiment projects obliquely upwardly toward an end face 21c of a sunroof panel 21 from a lower end of a leg portion 72 and comes in elastic area contact with the end face 21c of the sunroof panel 21 in the same manner as in the first embodiment. Also, this contact lip 74 is formed of one piece in the same manner as in the first embodiment. Also, a convex portion 76 as movement preventing means for preventing the elastic sealing material 50 from moving toward the leg portion 72 is formed on the elastic sealing material 50 side of the contact lip 74. Further, recess grooves 77 are formed at boundary positions between the leg portion 72 and the contact lip 74.

Accordingly, in accordance with the panel mounting structure of the second embodiment, it is possible to prevent the elastic sealing material 50 from moving in the direction toward the leg portion 72 by the convex portion 76 provided on the elastic sealing material 50 side of the contact lip 74. For instance, even if the region into which the elastic sealing material 50 may be introduced is formed between the leg portion 72 and the contact lip 74, it is possible to prevent the elastic sealing material 50 from moving in the direction between the leg portion 72 and the contact lip 74. Accordingly, there is no fear that the elastic sealing material 50 is introduced into this region. The number, the shape or the like of the movement preventing means is not limited and may be changed as desired. For example, the movement preventing means may be a hook-shaped projection. Also, the position where the movement preventing means is provided is not limited to the contact lip 74. For instance, it is possible to provide the movement preventing means on the side of the leg portion 72.

Also, it is possible to enhance the smoothness of the movement of the contact lip 74 by the grooves 77 provided at the boundary positions between the leg portion 72 and the contact lip 74.

Incidentally, in the first embodiment, although the slant surface 20d is provided at the end face 20c of the sunroof panel 20, it is possible to dispense with the slant surface as in the sunroof panel 21 shown in FIG. 5.

Third Embodiment:

A panel mounting structure in accordance with a third embodiment will now be described with reference to FIG. 6. Incidentally, the same reference numerals are used to indicate the same or like components as shown in FIG. 5.

As shown in FIG. 6, a contact lip 84 of a weather strip 80 in accordance with the third embodiment projects obliquely upwardly toward the end face 21c of the sunroof panel 21 from the substantially center position of the leg portion 82 and comes into contact with the end face 21c of the sunroof panel 21 with elasticity. Also, this contact lip 84 is formed of one piece as in the first embodiment.

Incidentally, it is preferable that the contact lip 84 projects from the lower end of the leg portion 82 as shown in the first embodiment. However, it is not always necessary that the contact lip 84 projects from the lower end of the leg portion 82. The arrangement of the contact lip 84 to the leg portion 82 is not limited and may be changed as desired.

Fourth Embodiment:

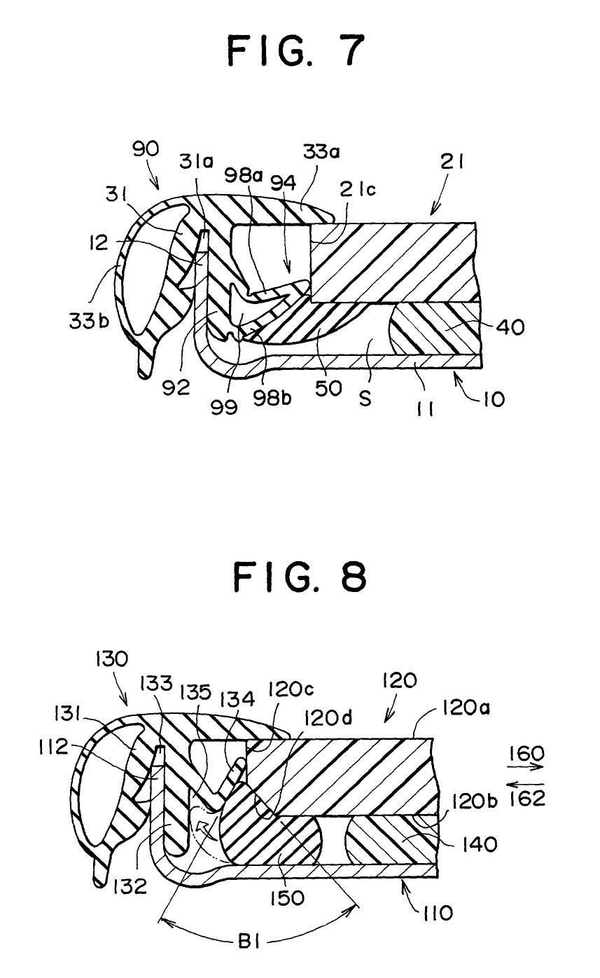

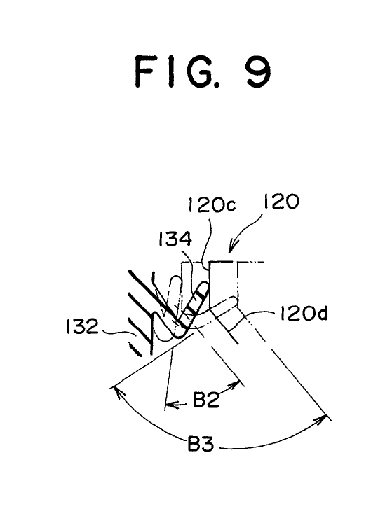

A panel mounting structure in accordance with a fourth embodiment will now be described with reference to FIG. 7. Incidentally, the same reference numerals are used to indicate the same or like components as shown in FIG. 5.

As shown in FIG. 7, a contact lip 94 of a weather strip 90 in accordance with the fourth embodiment has an upper portion piece 98a and a lower portion piece 98b. A hollow portion 99 is formed at a position surrounded by the leg portion 92 and the contact lip 94. In the same manner as in the other embodiments, the hollow-shaped contact lip 94 projects obliquely upwardly toward the end face 21c of the sunroof panel 21 from the leg portion 92 and comes into contact with the end face 21c of the sunroof panel 21 with elasticity. Incidentally, the upper portion piece 98a and the lower portion piece 98b are formed thinner than the contact lip of the other embodiments.

Accordingly, with the panel mounting structure in accordance with the above-described fourth embodiment, the contact lip 94 has an excellent followability to the end face 21c of the sunroof panel 21.

The present invention is not limited to the above-described first to fourth embodiments, and various modifications and applications are possible. For instance, the convex portion 76 as the movement preventing means of the elastic sealing material 50 in accordance with the second embodiment may be applied to the other embodiments other than the second embodiment.

In each of the foregoing embodiments, although the synthetic resin made sunroof panels 20, 21 have been described, the material of the light transmitting panel is not limited to the synthetic resin. For example, it is possible to apply the invention to the combination of the glass made light transmitting panel and the metal made frame. This combination has a less difference in linear expansion coefficient than the combination of the synthetic resin made sunroof panel and the metal made frame. However, since the amount of the relative shift at the end portion of the light transmitting panel is also in proportion to the size of the light transmitting panel, the present invention may be well applied, in particular, to the case where the size of the light transmitting panel is large. Namely, the present invention may be applied to the case where the materials having different linear expansion coefficients are applied to the light transmitting panel and the frame.

Also, in each of the foregoing embodiments, the sunroof panel mounting structure in the automotive sunroof has been described. However, it is possible to apply the present invention to any panel mounting structure to be mounted in a variety of vehicles other than the automotive vehicle or to be provided in other parts other than the sunroof.

What is claimed is:

1. An automotive light transmitting panel mounting structure for mounting a light transmitting panel to a frame, comprising:
a frame having a mounting flange;
a light transmitting panel bonded relatively movably to said frame;
a weather strip held by the mounting flange of said frame for sealing a space between said frame and said light transmitting panel; and
elastic sealing material filled in a space surrounded by said frame, said light transmitting panel and said weather strip;
said weather strip including:
a body portion;
a leg portion extending from said body portion to face said body portion for clamping the mounting flange of said frame in cooperation with said body portion; and
a contact lip projecting from said leg portion in elastic contact with an end face of said light transmitting panel so that said elastic sealing material is prevented from entering between said leg portion and said contact lip.

2. A structure according to claim 1, wherein said contact lip projects substantially in the form of a flat plate from said leg portion toward the end face of said light transmitting panel so that no space where said elastic seal material enters is formed between said leg portion and said contact lip.

3. A structure according to claim 2, wherein said contact lip projects from a tip end of said leg portion.

4. A structure according to claim 2, wherein said contact lip projects from an intermediate portion of said leg portion.

5. A structure according to claim 1, wherein said weather strip prevents said elastic sealing material from moving in a direction toward said leg portion.

6. A structure according to claim 5, wherein said weather strip has a convex portion projecting from said contact lip toward the space surrounded by said frame, said light transmitting panel and said weather strip for preventing said elastic sealing material from moving in a direction toward said leg portion.

7. A structure according to claim 1, wherein said contact lip has a hollow portion therein.

8. A structure according to claim 1, wherein grooves are formed in boundary positions between said leg portion and said contact lip of said weather strip.

9. A structure according to claim 1, wherein said weather strip has a surface side lip projecting from an end portion of the body portion in contact with a surface of said light transmitting panel.

10. A structure according to claim 1, wherein said weather strip has an outer side lip projecting from the body portion in a direction opposite to said light transmitting panel.

11. A structure according to claim 1, wherein said weather strip is made of rubber.
